(19) United States
(12) Patent Application Publication
(10) Pub. No.: US 2024/0195918 A1
(43) Pub. Date: Jun. 13, 2024

(54) MICROPHONE SELECTION IN MULTIPLE-MICROPHONE DEVICES

(71) Applicant: DSP Concepts, Inc., Santa Clara, CA (US)

(72) Inventor: James Brian Piket, Santa Clara, CA (US)

(21) Appl. No.: 18/080,146

(22) Filed: Dec. 13, 2022

(51) Int. Cl. H04M 9/08; G10L 21/0216; H04R 3/00

(52) U.S. Cl. CPC H04M 9/082; G10L 21/0216; H04R 3/005; G10L 2021/02082

(57) ABSTRACT

A method of microphone selection for double-talk situations, for an audio device including a plurality of microphones, a receive audio path and a transmit audio path is disclosed. The method includes detecting voice audio on the receive audio path, detecting no voice audio on the transmit audio path, capturing an echo signal generated by each of the plurality of microphones, determining an echo return parameter for each of the plurality of microphones from a level of the corresponding echo signal and a level of the receive audio, comparing the echo return parameters on each of the plurality of microphones to identify the microphone with the best echo return parameter, and setting the microphone with the best echo return parameter as a default microphone.

### BACKGROUND

Current audio devices for the transmission spoken audio, such as smart speakers and speakerphones, typically include a number of microphones. The outputs from the microphones are processed to improve the transmit audio, by performing echo cancellation, noise reduction, and so forth.

### BRIEF DESCRIPTION OF THE SEVERAL VIEWS OF THE DRAWINGS

Some example embodiments of the present disclosure are illustrated by way of example and not limitation in the figures of the accompanying drawings, in which like reference numbers indicate similar elements. To easily identify the discussion of any particular element or act, the most significant digit or digits in a reference number refer to the figure number in which that element is first introduced.

FIG. 1 illustrates an audio device according to some examples.

FIG. 2 illustrates a system in which a near end audio device is coupled to a server and a far end audio device according to some examples.

FIG. 3 illustrates an audio processing architecture for performing microphone selection in multiple-microphone devices according to some examples.

FIG. 4 illustrates a flowchart for providing evaluation of microphones according to some examples.

FIG. 5 illustrates a flowchart for providing customized audio processing according to some examples.

FIG. 6 illustrates a diagrammatic representation of a machine in the form of a computer system within which a set of instructions may be executed for causing the machine to perform any one or more of the methodologies discussed herein, according to an example.

### DETAILED DESCRIPTION

Business/enterprise voice communication devices require multiple microphones to improve transmit voice quality by utilizing directionality, through discrete directional elements or microphone arrays. In this manner the transmit signal-to noise ratio (SNR) and reverberation of the near-end talker can be improved. When both the near-end talker and the far-end talker are speaking at the same time, a double-talk condition occurs. Although double-talk is a very small percentage of a conversation, the ability for both parties to speak and be heard at the same time greatly enhances the flow and continuity of the conversation, and is important in all voice communication subjective and objective standards.

The performance during double-talk is dominated by the coupling and linearity of the echo path as captured by the device's microphones for the purpose of acoustic echo cancellation. The performance of a device in regard to echo can be described as the sum of the echo return loss (ERL) and the echo return loss enhancement (ERLE). ERL is the ratio, expressed in decibels, of the echo signal to the original signal. ERLE is the amount of additional signal loss performed by an echo canceller, also expressed in decibels, and is the ratio of the signal after the echo cancellation to the signal before the echo cancellation.

Acoustic echo in audio devices is affected by the coupling between the loudspeaker and the microphone through the air, and mechanically through the structure of the audio device. In devices with multiple microphones, the coupling and linearity for each individual microphone can vary significantly due to the device's industrial design, microphone locations, and speaker locations. Additionally, problems during assembly and aging of the device can affect different microphones differently. For example, problems with the mounting and sealing of a microphone during construction or over time can cause undesired coupling and distortion problems.

To improve double-talk performance, the device microphones can be monitored real-time and the ERL and ERLE can be estimated for each microphone during Rx (receive) single-talk. The device microphone(s) with the best ERL+ERLE performance can then be dynamically selected for use during double-talk conditions, to improve conversational transparency. In some examples, all microphones would be used (or there would be a return to a previous or default microphone configuration) when there is near-end speech (without double-talk) to get the maximum SNR, low reverb, and good quality.

In some examples, provided is a method of providing audio processing in an audio communications device including a plurality of microphones, a receive audio path and a transmit audio path, the method including detecting voice audio on the receive audio path, detecting no voice audio on the transmit audio path, capturing an echo signal generated by each of the plurality of microphones, determining an echo return parameter for each of the plurality of microphones from a level of the corresponding echo signal for each of the plurality of microphones and a level of the receive audio, comparing the echo return parameters on each of the plurality of microphones to identify at least one microphone with a better echo return parameter, and setting the at least one microphone with the better echo return parameter as a default microphone.

The default microphone may include an array of microphones having better echo return parameters. The default microphone may include a single microphone with the best echo return parameter.

The method may further include setting the at least one microphone with the better echo return parameter as a default microphone for use in double-talk conditions.

The method may further include detecting voice audio on the receive audio path, detecting voice audio on the transmit audio path, and based on detecting voice audio on both the receive audio path and the transmit audio path, capturing an audio signal for the transmit audio path from the default microphone.

The method may be performed automatically at a start of a voice call on the audio communications device or on power on of the audio communications device. The method may also be performed autonomously and continuously in operation of the audio communications device.

In some examples, provided is non-transitory computer-readable storage medium, the computer-readable storage medium including instructions that when executed by a computer, cause the computer to perform operations for providing audio processing in an audio communications device including a plurality of microphones, a receive audio path and a transmit audio path, the operations corresponding to the method steps and limitations set forth above, including but not limited to comprising detecting voice audio on the receive audio path, detecting no voice audio on the transmit audio path, capturing an echo signal generated by each of the plurality of microphones, determining an echo return parameter for each of the plurality of microphones from a level of the corresponding echo signal for each of the plurality of microphones and a level of the receive audio, comparing the echo return parameters on each of the plurality of microphones to identify at least one microphone with a better echo return parameter, and setting the at least one microphone with the better echo return parameter as a default microphone.

In further examples, provided is an audio device comprising a plurality of microphones, a receive audio path, a transmit audio path, a processor, and a memory storing instructions that, when executed by the processor, configure the audio device to perform operations for providing audio processing, the operations corresponding to the method steps and limitations set forth above, including but not limited to detecting voice audio on the receive audio path, detecting no voice audio on the transmit audio path, capturing an echo signal generated by each of the plurality of microphones, determining an echo return parameter for each of the plurality of microphones from a level of the corresponding echo signal for each of the plurality of microphones and a level of the receive audio, comparing the echo return parameters on each of the plurality of microphones to identify at least one microphone with a better echo return parameter, and setting the at least one microphone with the better echo return parameter as a default microphone.

Other technical features may be readily apparent to one skilled in the art from the following figures, descriptions, and claims.

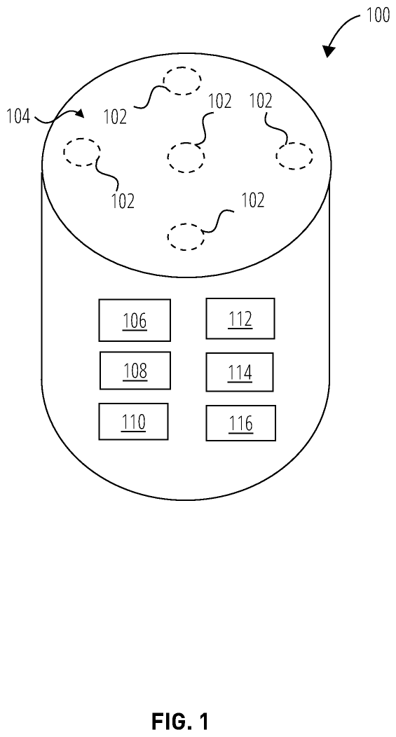

FIG. 1 illustrates an audio device 100 according to some examples. The audio device 100 includes several microphones 102 in a microphone array 104, one or more loudspeakers 116, and a network interface 106 used to communicatively couple with another audio device or a voice service over a network 202. Audio data received over the network 202 can be reproduced as audio signals for a user of the audio device 100 using the one or more loudspeakers 116, and audio data generated from audio received by one or more of the microphones 102 in the microphone array 104 can be transmitted from the audio device 100 over the network 202. Each audio device 100 may include a battery 114. The audio device 100 in some examples comprises a smart speaker or an audio conferencing device, but could be any device with audio playback and voice input.

Additionally, each audio device 100 include an audio processing unit 110 for processing received audio signals and/or signals from the one or more microphones 102. The audio processing unit 110 may be a software stack running on a physical DSP core (not shown), or other appropriate audio processing computing hardware, such as a networked processing unit, accelerated processing unit, a microcontroller, graphics processing unit or other hardware acceleration. The audio device 100 will have additional software such as an operating system, drivers, services, and so forth. The audio device 100 also include a processor 108 and memory 112. The memory 112 stores firmware for operating the audio device 100. The methods described herein are performed by a the processor, the audio processing unit 110 or a combination thereof.

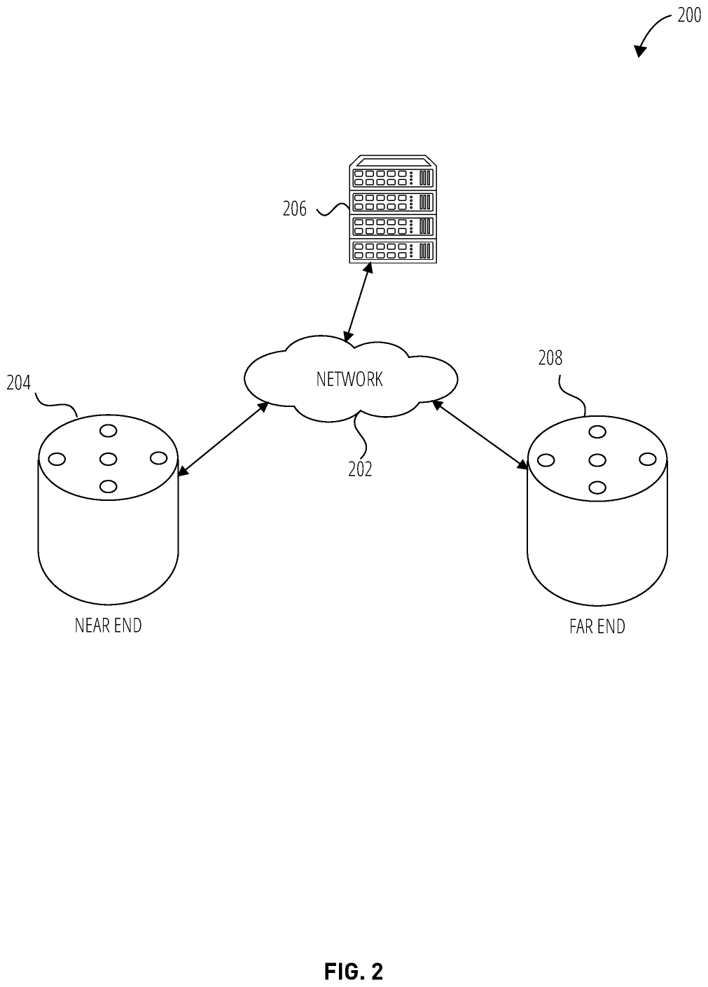

FIG. 2 illustrates a system 200 in which a near end audio device 204 is coupled to a server 206 and a far end audio device 208. The audio devices 204, 208 are instances of the audio device 100 described in FIG. 1.

In some examples, the network 202 may include the Internet, a local area network (“LAN”), a wide area network (“WAN”), and/or other data network over which voice audio is transmitted. In some examples, the voice transmission is by voice over IP (VOIP). In addition to traditional data-networking protocols, in some embodiments, data may be communicated according to protocols and/or standards including near field communication (“NFC”), Bluetooth, power-line communication (“PLC”), and the like. In some embodiments, the network 202 may also include a voice network that conveys not only voice communications, but also non-voice data such as Short Message Service (“SMS”) messages, as well as data communicated via various cellular data communication protocols, and the like.

The server 206 may host one or more voice services, such as a voice response or virtual assistant service, music streaming, cloud-based telephony services, audio and video conferencing, and so forth.

In some examples, some or part of the methods described herein as being performed by the audio device 100, and in particular a near end audio device 204, may be performed on the server 206.

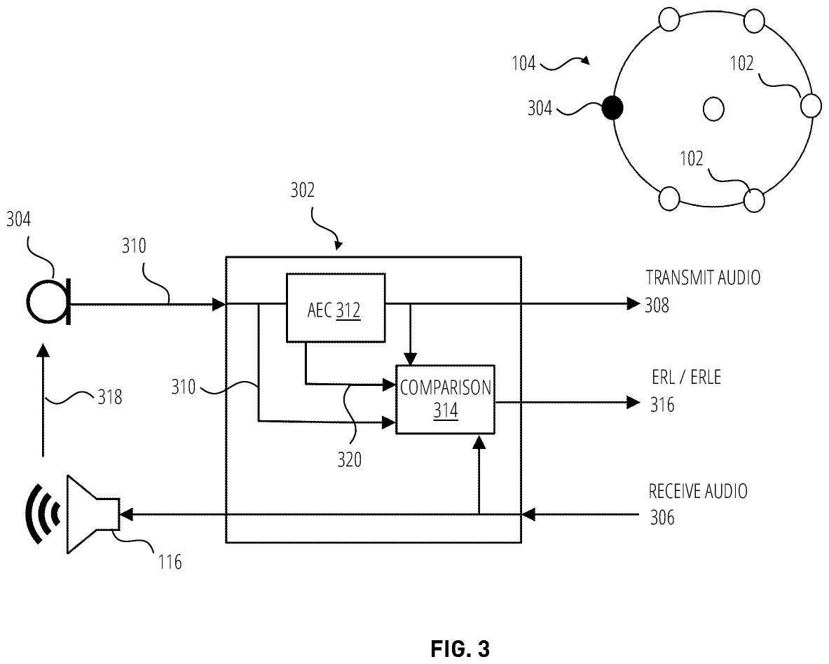

FIG. 3 illustrates an audio processing architecture 302 for performing microphone selection in multiple-microphone devices according to some examples. For simplicity, the architecture 302 does not include other audio processing elements that may be found in an audio device 100.

The architecture 302 receives a receive audio signal 306 from a far end audio device 208, which is provided as audible output at loudspeaker 116. The architecture 302 also provides a transmit audio signal 308, derived from a microphone input signal 310 from one or more of the microphones 102 in the array, for transmission to the far end audio device 208. During microphone selection as described herein, the microphone input signal 310 is captured when the near talker is silent, as determined by a voice activity detector in the audio device 100, which means that the microphone input signal 310 is then primarily based on the echo 318 received from the loudspeaker 116.

The architecture 302 also includes an AEC module 312 and a comparison module 314. The AEC module 312 performs known acoustic echo cancellation on the microphone input signal 310 as part of generating the transmit audio signal 308. The comparison module 314 receives the receive audio signal 306, the microphone input signal 310, the transmit audio signal 308 and echo data from the echo data path 320, and generates at least one echo return level output 316 therefrom. The echo data received from the AEC module 312 on the data path 320 comprises the AEC filter coefficients in some examples, from which the ERL can be derived.

When performing microphone selection, the microphone input signal 310 is from a microphone under test 304. The output 316 in some examples is the ERL (derived from the microphone input signal 310 and the receive audio signal 306), the ERLE (derived from the microphone input signal 310, and the transmit audio signal 308 and/or the AEC filter coefficients) or the overall echo return loss, derived from the receive audio signal 306 and the transmit audio signal 308. In some examples, a test tone can be used instead of using the receive audio signal 306.

Additionally or alternatively, the output 316 can be a value that combines the ERL or ERLE, or an echo return score based on the ERL and/or the ERLE.

In use, the architecture 302 steps through the microphones 102 to determine the echo return level outputs 316 for each microphone. The output 316 for each microphone under test 304 is then provided to the processor 108 or the audio processing unit 110, which sets the microphone 102 with the best echo-related performance as the default microphone, either generally or during double-talk situations.

In some examples, instead of a single microphone, the default microphone is a microphone array. To select microphones to form the array, each microphone 102 is tested as above, and either a group of best or better performing microphones is selected, or poorly performing microphones are eliminated from the available microphones. The beamformer filter coefficients for the for the new array of microphones are then calculated and used for audio captured by the microphone array.

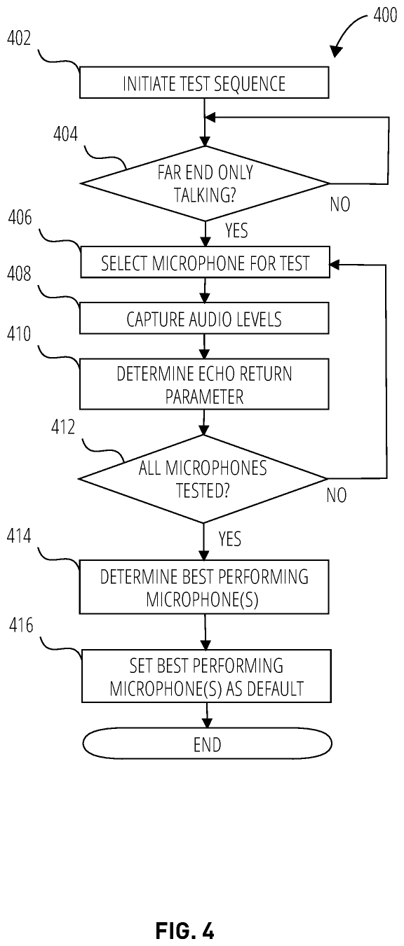

FIG. 4 illustrates a flowchart 400 for providing evaluation of microphones according to some examples. Although the flowchart may describe the operations as a sequential process, many of the operations can be performed in parallel or concurrently. In addition, the order of the operations may be re-arranged. A process is terminated when its operations are completed. A process may correspond to a method, a procedure, etc. The steps of the method may be performed in whole or in part, may be performed in conjunction with some or all of the steps in other methods, and may be performed by any number of different systems, such as any of the systems described herein. For illustrative purposes, flowchart 400 is described as taking place in audio device 100, in the processor 108, the audio processing unit 110 or some combination thereof

The flowchart 400 commences at operation 402 with initiation of a test sequence. This could happen at any time there is valid audio data, including automatically at the start of each call, on initial set-up or power on, in response to specific user input to do so, or autonomously and continuously in operation, and so forth. The flowchart 400 is described with reference to an evaluation that takes place during a call, but it will be appreciated that a test tone generated by the audio device 100 and emitted by the loudspeaker 116 could be used in the method with minor modifications.

In operation 404, the audio device 100 determines if only the far end talker is talking, namely that a receive audio signal 306 including voice is being received and that the near end talker is silent. This determination can be performed by voice activity detection as is known in the art. If this condition is not met, operation 404 is repeated at intervals until the audio device 100 determines that only a far end talker is talking.

The audio device 100 then selects a microphone 102 for testing in operation 408, and captures the associated audio input signal therefrom in operation 408. In operation 410 the audio device 100 determines an echo return parameter from the echo signal return levels using the levels of the receive audio signal 306, the microphone input signal 310 and/or the transmit audio signal 308. The echo return parameter quantifies the echo return performance of the microphone under test, and is for example the ERL, the ERLE, some combination thereof, or an echo return score based thereon. The echo return parameter is stored, together with an identifier of the corresponding microphone 102.

In operation 412 the audio device 100 then determines if all of the microphones have been tested. If not, the method returns to operation 406 where the next microphone is selected for testing. If all the microphones have been tested, the method proceeds at operation 414 where the top performing microphone is determined. This is done by selecting the microphone 102 with the best echo return parameter, such as the microphone with the best ERL, ERLE, combined ERL and ERLE value, or best echo return score.

In some examples, and as described above with reference to FIG. 3, in some examples the best microphone comprises a microphone array, in which a group of best or better performing microphones is selected, or poorly performing microphones are eliminated from the available microphones. The beamformer filter coefficients for the for the new array of microphones are then calculated and used for audio captured by the microphone array.

In operation 416, the audio device 100 sets the best performing microphone, which could be a microphone array, as the default microphone.

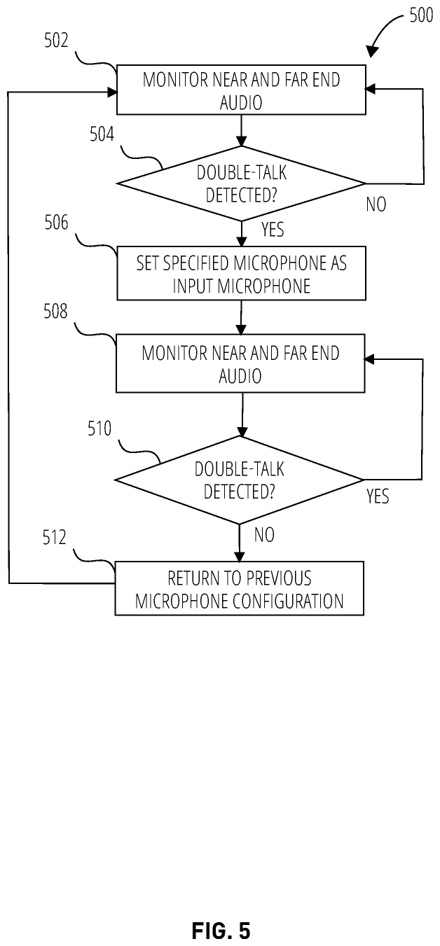

FIG. 5 illustrates a flowchart 500 for providing customized audio processing according to some examples. Although the flowchart may describe the operations as a sequential process, many of the operations can be performed in parallel or concurrently, for example the testing of more than on microphone 102 at the same time. In addition, the order of the operations may be re-arranged. A process is terminated when its operations are completed. A process may correspond to a method, a procedure, etc. The steps of the method may be performed in whole or in part, may be performed in conjunction with some or all of the steps in other methods, and may be performed by any number of different systems, such as any of the systems described herein. For illustrative purposes, flowchart 500 is described as taking place in audio device 100, in the processor 108, the audio processing unit 110 or some combination thereof.

The flowchart 500 commences at operation 502 with a call in progress, with the audio device 100 monitoring the receive audio signal 306 and the transmit audio signal 308 for double talk. If double talk is not detected in operation 504, the monitoring of the audio signals in operation 502 continues. If double talk is detected, the audio device 100 sets the microphone 102 that has been determined in flowchart 400 to be the best microphone, as the input microphone for the audio device 100, in operation 506.

The flowchart 500 the continues at operation 508 with the call in progress, with the audio device 100 monitoring the receive audio signal 306 and the transmit audio signal 308 for double talk. If (continuing) double talk is detected in operation 510, the monitoring of the audio signals in operation 508 continues. If double talk is not detected, the audio device 100 returns to the previous microphone configuration in operation 512. The flowchart 400 then returns to operation 502 and the method continues from there.

The flowchart 500 terminates when the call ends.

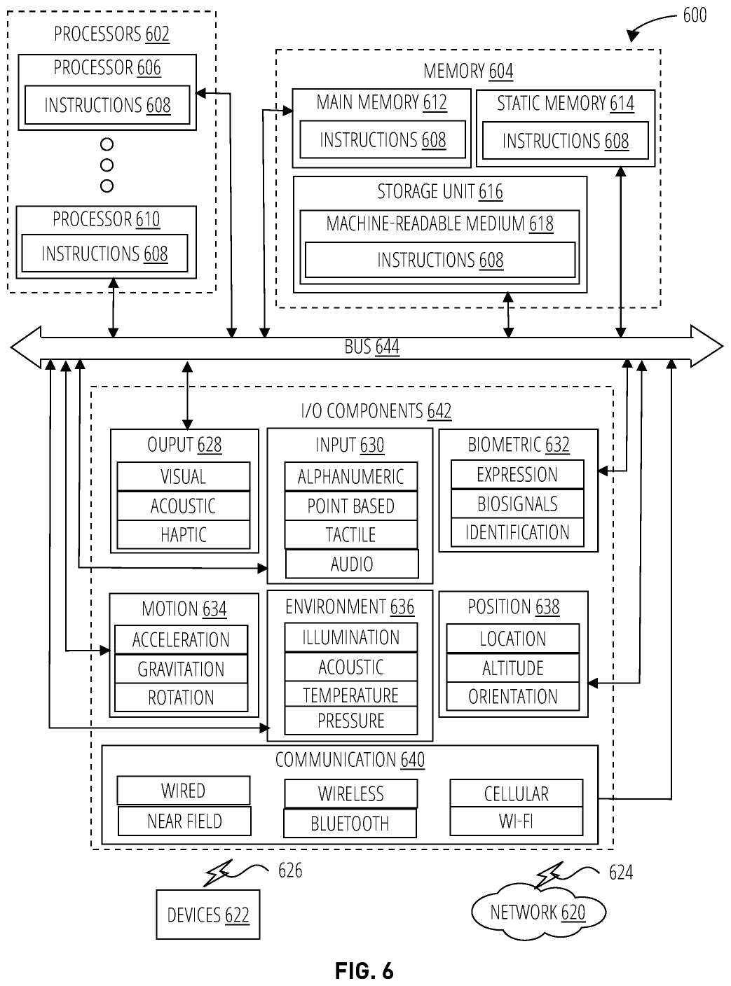

FIG. 6 illustrates a diagrammatic representation of a machine 600 in the form of a computer system within which a set of instructions may be executed for causing the machine to perform any one or more of the methodologies discussed herein, according to an example embodiment. Specifically, FIG. 6 shows a diagrammatic representation of the machine 600 in the example form of a computer system, within which instructions 608 (e.g., software, a program, an application, an applet, an app, or other executable code) for causing the machine 600 to perform any one or more of the methodologies discussed herein may be executed. For example the instructions 608 may cause the machine 600 to execute the methods described above. The instructions 608 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines 600 that individually or jointly execute the instructions 608 to perform any one or more of the methodologies discussed herein.

The machine 600 may include processors 602, memory 604, and I/O components 642, which may be configured to communicate with each other such as via a bus 644. In an example embodiment, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that may execute the instructions 608. The term “processor” is intended to include multi-core processors that may comprise two or more independent processors (sometimes referred to as “cores”) that may execute instructions contemporaneously. Although FIG. 6 shows multiple processors 602, the machine 600 may include a single processor with a single core, a single processor with multiple cores (e.g., a multi-core processor), multiple processors with a single core, multiple processors with multiples cores, or any combination thereof.

The memory 604 may include a main memory 612, a static memory 614, and a storage unit 616, both accessible to the processors 602 such as via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 within the storage unit 616, within at least one of the processors 602 (e.g., within the processor's cache memory), or any suitable combination thereof, during execution thereof by the machine 600.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones will likely include a touch input device or other such input mechanisms, while a headless server machine will likely not include such a touch input device. It will be appreciated that the I/O components 642 may include many other components that are not shown in FIG. 6. The I/O components 642 are grouped according to functionality merely for simplifying the following discussion and the grouping is in no way limiting. In various example embodiments, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 642 may include biometric components 632, motion components 634, environmental components 636, or position components 638, among a wide array of other components. For example, the biometric components 632 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 may include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near Field Communication (NFC) components, Bluetooth® components (e.g., Bluetooth® Low Energy), Wi-FiR components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

The various memories (i.e., memory 604, main memory 612, static memory 614, and/or memory of the processors 602) and/or storage unit 616 may store one or more sets of instructions and data structures (e.g., software) embodying or utilized by any one or more of the methodologies or functions described herein. These instructions (e.g., the instructions 608), when executed by processors 602, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of non-transitory machine-readable media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 620 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 620 or a portion of the network 620 may include a wireless or cellular network, and the coupling 624 may be a Code Division Multiple Access (CDMA) connection, a Global System for Mobile communications (GSM) connection, or another type of cellular or wireless coupling. In this example, the coupling 624 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 608 may be transmitted or received over the network 620 using a transmission medium via a network interface device (e.g., a network interface component included in the communication components 640) and utilizing any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 608 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

1. A method of providing audio processing in an audio communications device including a plurality of microphones, a receive audio path and a transmit audio path, the method comprising:
detecting voice audio on the receive audio path;
detecting no voice audio on the transmit audio path;
capturing an echo signal generated by each of the plurality of microphones;
determining an echo return parameter for each of the plurality of microphones from a level of the corresponding echo signal for each of the plurality of microphones and a level of the receive audio;
comparing the echo return parameters on each of the plurality of microphones to identify at least one microphone with a better echo return parameter; and
setting the at least one microphone with the better echo return parameter as a default microphone.

2. The method of claim 1, wherein the default microphone comprises an array of microphones having better echo return parameters.

3. The method of claim 1, wherein the default microphone comprises a single microphone with the best echo return parameter.

4. The method of claim 1, further comprising:
setting the at least one microphone with the better echo return parameter as a default microphone for double-talk conditions.

5. The method of claim 1, further comprising:
detecting voice audio on the receive audio path;
detecting voice audio on the transmit audio path; and
based on detecting voice audio on both the receive audio path and the transmit audio path, capturing an audio signal for the transmit audio path from the default microphone.

6. The method of claim 5, wherein the default microphone comprises an array of microphones.

7. The method of claim 1, wherein the method is performed automatically at a start of a voice call on the audio communications device or on power on of the audio communications device.

8. The method of claim 1, wherein the method is performed autonomously and continuously in operation of the audio communications device.

9. A non-transitory computer-readable storage medium, the computer-readable storage medium including instructions that when executed by a computer, cause the computer to perform operations for providing audio processing in an audio communications device including a plurality of microphones, a receive audio path and a transmit audio path, the operations comprising:
detecting voice audio on the receive audio path;
detecting no voice audio on the transmit audio path;
capturing an echo signal generated by each of the plurality of microphones;
determining an echo return parameter for each of the plurality of microphones from a level of the corresponding echo signal for each of the plurality of microphones and a level of the receive audio;
comparing the echo return parameters on each of the plurality of microphones to identify at least one microphone with a better echo return parameter; and
setting the at least one microphone with the better echo return parameter as a default microphone.

10. The non-transitory computer-readable storage medium of claim 9, wherein the default microphone comprises an array of microphones having better echo return parameters.

11. The non-transitory computer-readable storage medium of claim 9, wherein the default microphone comprises a single microphone with the best echo return parameter.

12. The non-transitory computer-readable storage medium of claim 9, wherein the operations further comprise:
detecting voice audio on the receive audio path;
detecting voice audio on the transmit audio path; and
based on detecting voice audio on both the receive audio path and the transmit audio path, capturing an audio signal for the transmit audio path from the default microphone.

13. The non-transitory computer-readable storage medium of claim 9, wherein the operations are performed automatically at a start of a voice call on the audio communications device or on power on of the audio communications device.

14. The non-transitory computer-readable storage medium of claim 9, wherein the operations are performed autonomously and continuously in operation of the audio communications device.

15. An audio device comprising:
a plurality of microphones;
a receive audio path;
a transmit audio path;
a processor; and
a memory storing instructions that, when executed by the processor, configure the audio device to perform operations for providing audio processing, the operations comprising:
detecting voice audio on the receive audio path;
detecting no voice audio on the transmit audio path;
capturing an echo signal generated by each of the plurality of microphones;
determining an echo return parameter for each of the plurality of microphones from a level of the corresponding echo signal for each of the plurality of microphones and a level of the receive audio;
comparing the echo return parameters on each of the plurality of microphones to identify at least one microphone with a better echo return parameter; and
setting the at least one microphone with the better echo return parameter as a default microphone.

16. The audio device of claim 15, wherein the default microphone comprises an array of microphones having better echo return parameters.

17. The audio device of claim 15, wherein the operations further comprise:
setting the at least one microphone with the better echo return parameter as a default microphone for double-talk conditions.

18. The audio device of claim 15, wherein the operations further comprise:
detecting voice audio on the receive audio path;
detecting voice audio on the transmit audio path; and
based on detecting voice audio on both the receive audio path and the transmit audio path, capturing an audio signal for the transmit audio path from the default microphone.

19. The audio device of claim 15, wherein the operations are performed automatically at a start of a voice call on the audio device or on power on of the audio communications device.

20. The audio device of claim 15, wherein the operations are performed autonomously and continuously in operation of the audio device.
